(19) United States
(12) Patent Application Publication
(10) Pub. No.: US 2026/0221076 A1
(43) Pub. Date: Jul. 30, 2026

(54) FAST AND LIGHTWEIGHT WRITING OR READING OF PIXELS OF A 2D SHAPE IN AN ACTIVE MATRIX DIGITAL DISPLAY

(71) Applicant: MICROOLED, Grenoble (FR)

(72) Inventors: Laurent CHARRIER, Grenoble Cedex 9 (FR); Matthieu WINDIC, Grenoble Cedex 9 (FR); Thomas CUBIZOLLE, Grenoble Cedex 9 (FR)

(73) Assignee: MICROOLED, Grenoble (FR)

(21) Appl. No.: 19/142,382

(22) PCT Filed: Dec. 19, 2023
(86) PCT No.: PCT/EP2023/086674

§ 371 Date: Jun. 23, 2025

(30) Foreign Application Priority Data
Dec. 23, 2022 (EP) 22307036.8

(51) Int. Cl. G09G 3/20

(52) U.S. Cl. CPC G09G 3/2096; G09G 2300/0857; G09G 2354/00

(57) ABSTRACT

The invention relates to an active matrix digital display comprising: a plurality of pixels, each pixel comprising a static memory storing one or more values of intensity of the pixel; an interface configured, upon the reception of at least one command to: obtain an identifier of a type of the command; if the type of the command of the command belongs to at least one type relative to a 2D shape: reading, in a predefined position of a payload of the command, at least one parameter relative to at least a pixel position in the display screen; writing to the static memories of a subset of pixels of the screen from the payload of the command, or reading from said static memories of the subset of pixels, values of intensities said subset of pixels based at least on said at least one parameter.

### TECHNICAL FIELD

This disclosure pertains to the field of active matrix digital displays; More specifically, it pertains to the field of pixel writing or reading in active matrix digital displays.

### BACKGROUND ART

Active matrix digital displays are displays wherein each pixel is associated with an address and comprises a memory storing one or more pixel intensities, and each pixel can be read or written independently. An active matrix display may be for example a LCD, AMOLED or AMLED display or microdisplay.

The memory of a pixel may store a single value of intensity if the pixel is a grayscale pixel, or a plurality of values of intensities of a plurality of color layers if the pixel is a color pixel such as a RGB pixel for example. Each pixel may further comprise a DAC (Digital to Analog Converter) that converts the values of intensities stored in the memory of the pixel into a voltage or current of one or more electroluminescent element of the pixel.

The memories of the pixel may be static memories, such as SRAM (Static Random Access Memories), or volatile memories. Volatile memories need to be refreshed, while the values stored in static memories remains stored without time limitation, until being erased and replaced by a new values. Pixels comprising static memories are for example described by Hao, D., Aiying, G., & Feng, R. (2020, November). A New Low-power Pixel Circuit for OLEDoS Microdisplay. In 2020 17th China International Forum on Solid State Lighting & 2020 International Forum on Wide Bandgap Semiconductors China (SSLChina: IFWS) (pp. 211-214). IEEE., and Vogel, U., Beyer, B., Schober, M., Wartenberg, P., Brenner, S., Bunk, G., . . . & Richter, B. (2017, May). 77-1: Invited Paper: Ultra-low Power OLED Microdisplay for Extended Battery Life in NTE Displays. In SID Symposium Digest of Technical Papers (Vol. 48, No. 1, pp. 1125-1128).

Active matrix digital displays are usually provided with an interface which is responsible for receiving commands and writing pixels intensities in memory accordingly, or conversely reading pixel intensities in memory. The interface may be a serial interface, or a parallel interface. Examples of serial interfaces comprise for example I2C, SPI or CAN interfaces, although virtually any kind of serial interface can be used in active matrix digital displays.

When an active matrix display needs to be written or read, a command is usually sent which comprises a bitmap image of all the pixels of the display to be read or written. Thus, all the values of intensities of all the pixels of the image are transferred through the interface. This causes a significant delay in writing or reading the values, and consumes a significant amount of energy.

There is therefore the need for a reduction of the amount of data to be transferred for writing or reading an active matrix display screen.

### SUMMARY

This disclosure improves the situation.

It is proposed an active matrix digital display comprising: a plurality of pixels, each pixel comprising a static memory storing one or more values of intensity of the pixel; an interface configured, upon the reception of at least one command to: obtain an identifier of a type of the command; if the type of the command of the command belongs to at least one type relative to a 2D shape: reading, in a predefined position of a payload of the command, at least one parameter relative to at least a pixel position in the display screen; writing to the static memories of a subset of pixels of the screen from the payload of the command, or reading from said static memories of the subset of pixels, values of intensities of said subset of pixels based at least on said at least one parameter

By “static memory” we designate a memory where values are stored permanently until a further modification. A static memory may for example a SRAM (“Static Random Access Memory”). In a static memory digital display, the static memory stores intensities of pixels, and the display screen displays at any time the current value of the intensity of each pixel as stored in the static memory.

By “interface”, we designate an interface that is able to receive commands and analyze commands to write or read in the static memory accordingly. The interface may comprise wires and an electronic circuit. The interface may for example be a serial or a parallel input interface. A serial interface may for example by a SPI interface. The interface may be an input interface, or a input and an output interface.

By “an identifier of the type of the command”, we designate a fraction of the command, for example a bit pattern, which designate which to which type the command belongs to.

By “2D shape”, we designate a shape defined as a series of pixels in 2 dimensions. The 2D shape may be a generic shape (rectangle, triangle, square...) associated with at least one parameter of dimension or a specific shape defined by a precise sequence of pixels, such as a mouse arrow for example.

By “at least one parameter relative to at least a pixel position in the display screen, we designate at least one parameter that allow retrieving a pixel position in the screen so that the position of the 2D shape in the display screen can be identified.

By “one or more values intensity”, we designate at least one intensity that defines the layout of the pixel.

The layout of a pixel may be defined by a single value of intensity, for example if the pixels are grayscale pixels, or a plurality of values of intensities, for example if the pixels are defined by a plurality of color channels. For example, a RGB pixel comprises 3 sub-pixels, each of the 3 sub-pixels being associated to one value of intensity. Other color representations are also usable, such as RG (2 color channels for Red and Green, for two sub-pixels for each pixel) or RGBW (4 color channels for Red, Green, Blue and White, for two sub-pixels for each pixel) representation for example.

The pixel position may be for example a position of a specific pixel of the shape, such as for example the top left corner of a rectangle, or an extremity of an arrow. The invention is however not restricted to this example, and each pixel position allowing to precisely locating the 2D shape in the screen can be used

The pixel position may be for example expressed using a row and a column number.

The at least one parameter may, in certain cases, comprise other parameters in addition of a pixel position. Such other parameters may for example comprise for example:
an indicative of a 2D shape (for example, is the 2D shape a square, a rectangle or a triangle), if this is not defined by the command type;
a size of the 2D shape;
An orientation of the 2D shape;
Etc.

This allows reading or writing only a part of the pixels of the screen. As the screen is equipped with static memory, in case of writing the pixels can keep their intensities as long

as they are not rewritten. Therefore, this provides a faster pixels reading/writing, and saves energy compared to a complete writing/reading of the pixels of the screen.

In another aspect, it is proposed a display device comprising: the active matrix digital display according to an embodiment of the invention; a processing unit configured to send to the interface of said digital display at least one command.

We designate by “processing unit” an electronic component capable of performing electronic or computer calculations for a function. A processing unit can designate any type of processor or electronic component capable of performing digital calculations. For example, a processing unit can be an integrated circuit, an ASIC (from the English acronym “Application-Specific Integrated Circuit”, literally in French “integrated circuit specific to an application”, a microcontroller, a microprocessor, a Digital Signal Processor (DSP), a processor, a Graphical Processing Unit (GPU). A processing unit according to the invention is not limited to a particular type of calculation architecture. For example, a processor can implement a Harvard or Von Neumann type architecture.

In another aspect, it is proposed a method executed by a digital display comprising: a plurality of pixels, each pixel comprising a static memory storing one or more values of intensity of the pixel; an interface; said method comprising: receiving, by the interface, at least one command; if the type of the command of the command belongs to at least one type relative to a 2D shape: reading, in a predefined position of a payload of the command, at least one parameter relative to at least a pixel position in the display screen; writing to the static memories of a subset of pixels of the screen from the payload of the command, or reading from said static memories of the subset of pixels, values of intensities of said subset of pixels based at least on said at least one parameter.

In another aspect, it is proposed a software or system firmware comprising instructions to implement at least a part of a method according to an embodiment of the invention when the software or system firmware is executed by a processor.

By “system firmware”, we designate a software that is directly embedded in a device, and participates to the functioning of the device.

In another aspect, it is proposed a computer-readable non-transient recording medium on which a software or system firmware is registered to implement a method according to an embodiment of the invention when the software or system firmware is executed by a processor.

The following features, can be optionally implemented, separately or in combination one with the others:

In a number of embodiments of the invention, the payload of the command further comprises at least one parameter defining the layout of the 2D shape, and said interface is configured to write or read said values of intensities according to said at least one parameter defining the layout of the 2D shape.

By “at least one parameter defining the layout of the 2D shape”, we designate at least one parameters the shape or intensities of pixels of the 2D shape. The at least one parameter defining the layout of the 2D shape may comprise at least one of:
a pixel intensity or color of all the pixels of the shape;
at least one parameter defining an effect to apply to the 2D shape, such as a color gradient;
Etc.

This allows reading or writing the 2D shape using only parameters, therefore leading to a much more efficient storage of 2D shapes that can be defined by parameters.

In a number of embodiments of the invention, said payload of the command comprises the values of intensities of said subset of pixel, and said interface is configured to write or read said values of intensities according to a pixel path associated to said 2D shape.

By “pixel path”, we designate a series of absolute or relative position of pixels for going through the whole 2D shape. For example:
if the 2D shape is a rectangle, the pixel path may consist in reading or writing the lines of the rectangle from top to bottom and from left to right;
if the 2D shape is a mouse arrow, the pixel path may consist in reading or writing the pixels of the arrow from top to bottom and from left to right, with a different number of pixels at each line;
Etc.

The pixel path may be associated to the command type, or defined by one or more parameters of the command. For example, if the commands aim at writing a rectangle, at least one parameter may define if the rectangle is to be written from top to bottom or from bottom to top.

This allows reading or writing the 2D shape pixel by pixel, while reading or . writing only the pixels of the 2D shape, thereby providing a faster reading or writing of 2D shapes defined by pixel values.

In a number of embodiments of the invention, said type of the command defines a 2D shape associated to a predefined pixel path.

By “predefined pixel path”, we designate a path which is known in advance and fully defines the shape. For example, if the 2D shape is a mouse arrow, the pixels of the arrow can be numbered, and the payload of the command may contain in the order of increasing number of the pixels, so the pixels can be read or written in the relevant relative position only based on the command type, and a single pixel position.

This this allows reducing the command sizes for specific 2D shapes, because the payload of the command does not need to contain parameters relative to a dimension of the shape to determine the pixel path. The reduction of the command size further reduces the energy consumption of the digital display.

In a number of embodiments of the invention, said at least one parameter further comprises at least one parameter relative to at least one dimension of the 2D shape; the size of the payload of the command is dependent upon said at least one dimension; the pixel path is parameter according to said at least one dimension.

By “at least one dimension of the 2D shape”, we designate at least one parameter which defines at least one dimension of the shape. Such at least one dimension may be for example:
a height and width of a rectangle;
a radius of a circle, the length of a side of a square;
a surface of a square;
a second pixel position which allows inferring the dimensions of the shape;
etc.

This allows defining shapes of different sizes, such as rectangles, square or triangles of different sizes, and storing in the command only the data relative to a 2D shape of said size. Therefore, this allows sending and processing only the data that is useful according to the size of the shape. The combination of the pixel position and dimension of the shape allows defining shapes of various positions and sizes.

In a number of embodiments of the invention, said 2D shape is a rectangle; said at least one parameter comprises: a row index of a first predefined corner of the rectangle; a column index of said first predefined corner of the rectangle; a row index of a second predefined corner of the rectangle, said second predefined corner being opposite to said first predefined corner; a column index of said second predefined corner of the rectangle.

By “opposite to”, we designate a second corner of the rectangle which is at the exact opposite of the first corner of the rectangle. For example:
the top-left corner and the bottom-right corner are opposite corners;
the top-right corner, and the bottom-left corner are opposite corner.

This provides an efficient way of defining all the parameters needed to locate a rectangle, and therefore reduce the command size for reading or writing a rectangle. The reduction of the command size further reduces the energy consumption of the digital display

In a number of embodiments of the invention, said 2D shape is a rectangle; said at least one parameter comprises: a row index of a first predefined corner of the rectangle; a column index of said first predefined corner of the rectangle; a height of the rectangle; a width of the rectangle.

This provides an efficient way of defining all the parameters needed to locate a rectangle, and therefore reduce the command size for reading or writing a rectangle. The reduction of the command size further reduces the energy consumption of the digital display.

In a number of embodiments of the invention, said 2D shape is a discus; said at least one parameter comprises: a row index of a predefined point associated to the discus; a column index of the predefined point associated to the discus; a parameter relative to a size of the discus.

By “a predefined point associated to the discus”, we designate a point that can be precisely located with reference to the discus. Such a predefined point may be for example a center of the discus, a top, bottom, extreme left or extreme point of the discus, a corner of a square that encompasses the square, or more generally any point that can be located with respect to the discus, and thus whose position allows locating the discus.

By “a parameter relative to a size of the circle”, we define a parameter that defines the size of the discus. For example such a parameter may be a radius, a diameter, a surface or a perimeter of the discus.

The position of the predefined point, and the parameter relative to the size of the circle allow completely defining the position of the size of the discus.

This provides an efficient way of defining all the parameters needed to locate a discus, and therefore reduce the command size for reading or writing a discus. The reduction of the command size further reduces the energy consumption of the digital display.

In a number of embodiments of the invention, said 2D shape is a triangle; said at least one parameter comprises the positions of the 3 corners of the triangle.

By “positions of the 3 corners of the triangle”, we define the row and column indexes of each of the 3 corners of the triangle.

The positions of the 3 corners of the triangle allow defining any triangle, and asserting which are the pixels that are comprised or not in the triangle.

This provides an efficient way of defining all the parameters needed to locate a triangle, and therefore reduce the command size for reading or writing a triangle. The reduction of the command size further reduces the energy consumption of the digital display.

In a number of embodiments of the invention, said at least one parameter comprises a parameter defining a command pixel depth lower than the depth of the pixels in the static memory; said interface is configured to perform a conversion between the command pixel depth and the depth of the pixels in the static memory.

By “conversion between the command pixel depth and the depth of the pixels in the static memory”, we designate a conversion between tow pixel representations. For example, if pixels are written from a the payload of the command, the interface converts the bit depth of the pixels in the payload of the command to the bit depth of the pixels in the static memory. Conversely, if the command is a read command which requires a bit depth lower than the bit depth of the pixel representation in the static memory, the interface performs a conversion of the bit depth of the pixels in the static memory to the bit depth required by the command.

This allows sending a command to write or read pixels in a bit depth which is lower than the bit depth of the representation of the pixels in the static ram. Therefore, the size of the pixel representation of the 2D shape is reduced, provided that less bits are required to represent the pixels. Meanwhile, the conversion performed by the interface allows ensuring that pixels are correctly represented. Therefore, the size of the command, or a backward message when pixels are read, can be reduced when only a lower bit depth is required. The reduction of the command size further reduces the energy consumption of the digital display.

In a number of embodiments of the invention, said processing unit is configured, upon the displacement of an object from an initial position to a final position in a 2D scene, to: send to the interface of said digital display a first command to write pixels of a first 2D shape that encompasses the object at the initial position and represents the background of the 2D scene; send to the interface of said digital display a second command to write pixels of a second 2D shape that encompasses the object at the final position and represents the object.

This allows, when an object moves in a 2D scene from the first to the second position, to first redraw the background in the first position, then draw the object in the second position. Therefore, if the representation of the object in the first and second position overlap, the object will not appear in double.

Furthermore, this allows sending the minimal amount of data for representing the displacement of the object, provided that no other part of the 2D scene is impacted by the displacement.

### BRIEF DESCRIPTION OF DRAWINGS

Other features, details and advantages will be shown in the following detailed description and on the figures, on which:

FIG. 1 represents an example of a system in which the invention can be implemented, in a number of embodiments of the invention.

FIG. 2 represents an example of an architecture of a display system in a number of embodiments of the invention.

FIG. 3 represents an example of a method according to number of embodiments of the invention.

FIG. 4 represents an example of command to write a rectangle whose position and dimensions are defined by the positions of two opposite corners, in a number of embodiments of the invention.

FIG. 5 represents an example of command to write a rectangle whose position and dimensions are defined by the position of a corner of the rectangle, and its dimensions, in a number of embodiments of the invention.

### DESCRIPTION OF EMBODIMENTS

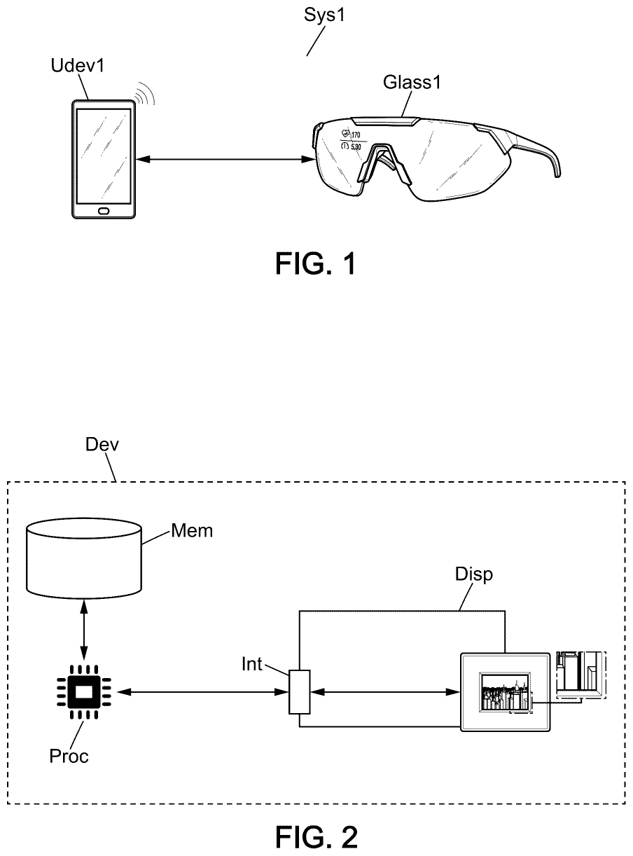

It is now referred to FIG. 1.

FIG. 1 represents an example of a system Sys1 in which the invention can be implemented.

The system Sys1 comprises a user device Udev1, and a pair of glasses Glas1.

In the example of FIG. 1, the user device which is represented is a smartphone. The invention is however not restricted to this example, and different user devices with connection capabilities, such as a smartwatch a tablet or the like may be used.

The user device Udev1 is connected to a pair of glass Glas1, for example by a short range radio connection, such as a Bluetooth connection.

The pair of glasses Glas1 may be a glass configured to display information in superposition to the view from the glasses, for example using a OLED display. For example, the applicant developed the Activelook® glasses which use a microoled display to represent information in superposition to the scene that the wearer views through the glasses. The Activelook glasses are equipped with lightweight memory and computing resources to process the display commands sent by the user device Udev1, so that the Activelook glasses are light, comfortable and perfectly fit for sports or other outdoor uses.

The user device Udev1 can thus send commands to the glasses Glas1 to display information in superposition to the scene which is viewed through the glasses. For example, if the user is running, the user device Udev1 can be equipped with sensors to measure information such as the running speed, heart rate of the user, duration of the run, etc. and send commands representing this information to the glasses Glas1, so that the user is able to see through the glasses his running speed, heart rate etc. while running. Meanwhile, the glasses Glas1 receives only display commands, and do not need to be equipped with powerful processors to process complex information such as the information provided by the sensors.

One of the objectives of the system Sys1 is to minimize the amount of data to be transferred from the device Udev1 to the pair of glasses Glas1, and processed by the pair of glasses Glas1. The invention can be used to this effect in order to reduce the size of the data frames that are transmitted by the user device Udev1 to the pair of glasses Glas1.

The system Sys1 is however provided by means of non-limitative example only of a system in which the invention can be implemented. The invention can indeed be implemented by other systems comprising an active matrix display. For example, other kind of near eye display devices than glasses may be used.

It is now referred to FIG. 2.

FIG. 2 represents an example of an architecture of a display device in a number of embodiments of the invention.

The display device Dev comprises:
an active matrix digital display Disp comprising:
   a plurality of pixels, each pixel comprising a static memory storing one or more values of intensity of the pixel;
   an Interface Int;
a processing unit configured to send to the interface of said digital display at least one command.

The processing unit is therefore configured to send commands to the interface Int to write the memories of the pixels of the display Disp in order to cause a modification of the display, or conversely a command to read the current values of the memories of the pixels in order to determine what is currently displayed.

The interface may be a serial or parallel interface. For example, it may be a Serial Peripheral Interface. The interface is able to process the commands, write and read the intensities of pixels, receive pixel intensities to write, and send pixel intensities that have been read.

The display device may be of various type. For example, it may be a pair of glasses such as the glasses Glas1, or another kind of near-eye device.

The digital display Disp is configured to execute a method such as the method P3 described below.

As will be explained in more details below, this allows the processor Proc to send commands that define subsets of the display screen to write or read, and which comprise only the information to read or write the values of intensities of the pixel in the subsets of the screen.

For example, when the content of the display is to be modified, the display Disp may receive commands to modify only subsets of the display that are modified.

According to various embodiments of the invention, the processing unit may perform complex operations to determine the commands to send, that is to say the type of command and the associated payload, or receive directly the command to send.

For example, if the display device Dev is the pair of glasses Glas1, the processor Proc may receive directly the commands to send from the user device Udev1, or receive higher level commands and perform calculations to determine the commands to send to the display Disp.

For example:
the processor Proc may receive from the user device Udev1 commands to display a text in a corner of the display Disp. The text to display may for example be the time of the day, in a format “HH:MM” (the hour: minutes, for example “17:05” for 5 p.m and 5 minutes). The processor Proc may receive a new command each minute, when the display needs to be modified;
as the pixels have static memories, only the pixels whose intensity have changed may thus be modified. The processor Proc may thus be configured to send a command to the interface Int to modify only a subset of the display where pixels are modified. To this effect, the processor Proc may have access to a memory Mem wherein the current state of the display is stored in the form of a bitmap image, in order to be permanently aware of the state of each pixel of the display.

In another example, the processor Proc receives coordinates of an object to displace from an initial position to a final position, for example a mouse cursor.

The processing unit may thus be configured to:
send to the interface Int a first command to write pixels of a first 2D shape that encompasses the object at the initial position and represents the background of the 2D scene;
send to the interface Int a second command to write pixels of a second 2D shape that encompasses the object at the final position and represents the object.

Stated otherwise, in order to displace an object in a 2D scene, the processing unit can send a first command to redraw the background of the 2D scene at the initial position, then a second command to draw the object at the final position.

For each command, pixels are written only in a 2D shape that encompasses the object. Therefore, a minimal amount of data is sent to the interface.

These examples demonstrate how the invention can be used to modify dynamically the display while sending minimal amount of data to the interface. They are however provided by means of non-limitative examples of a use of the invention to modify the display of the display device Dev.

More generally, a processing unit which sends commands to the interface Int is able to use commands to read or write pixels only in 2D shapes wherein there are pixel intensities to read or write.

We will now describe in greater details how the commands are processed by the interface Int.

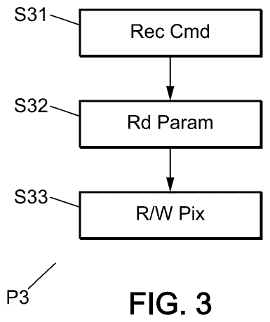

It is now referred to FIG. 3.

FIG. 3 represents an example of a method according to a number of embodiments of the invention.

The method P3 is a method executed by a display comprising a plurality of pixels, each pixel comprising a static memory storing one or more values of intensity of the pixel, and an interface, such as for example the display Disp represented in FIG. 2.

The method P3 comprises a first step S31 of receiving, by the interface, at least one command.

The command may be a command to read or write the memories of the pixel.

The command may comprise:
an identifier of the command, which defines a command type, and the organization of the payload of the command (e. g the position of the parameters in the payload, the size of the command, etc.;
the payload of the command.

The type of the command may belong to different types. For example, some commands may be used to read or write the whole screen. Some other commands may be used to read or write a 2D shape which forms a subset of the screen.

If the type of the command belongs to at least one type relative to a 2D shape, the method P3 further comprises a second step S32 of reading, in a predefined position of a payload of the command, at least one parameter relative to at least a pixel position in the display screen.

Stated otherwise, the type of command allows retrieving predefined types and positions of at least one parameter of the command, and the step S32 consists in reading, at the predefined positions, at least one parameter of the command. The positions of the pixel may be expressed as a row and a column index in the screen for example.

The at least one parameter of the command comprises at least a pixel position in the display screen, and may also comprise other parameters relative for example to the size, shape or orientation of the 2D shape.

The size and shape of the 2D shape are therefore known, at the output of step S32, either from the at least one parameter, the command type, or a combination thereof.

For example:
the command type may define a precise shape, for example an object whose size is known. The use of a parameter relative to a defined pixel of the shape (for example, the pixel at the extremity of a mouse cursor), is therefore sufficient to determine precisely all the pixels in the screen that belong to the shape;
the command type may define a shape type, for example a rectangle, and the at least one parameter may define the rectangle size, for example its height and width. In combination with the position of at least one pixel, this also allows determining precisely all the pixels in the screen that belong to the shape.

Therefore, at the end of step S32, the size and position of the 2D shape are known.

The method P3 further comprises a third step S33 of writing to the static memories of a subset of pixels of the screen, or reading from said static memories of the subset of pixels, values of intensities of said subset of pixels based at least on said at least one parameter.

Stated otherwise, the intensities of the pixels are read or written only for the pixels in the 2D shape which is defined by the identifier of the command and the at least one parameter. Thus, the amount of data that is transferred is reduced. The method P3 therefore allows reducing the time to read or write the pixels, and saving energy in the process of writing or reading the intensities of pixels.

In general, writing pixels is based on reading the payload, and writing the intensities of the pixels in the memories of the pixels accordingly, while reading pixels is based on reading the pixels intensities in the memories of the pixels, filling the payload accordingly and sending back the information, for example to the processing unit Proc.

Writing or reading the pixel intensities may be performed in different ways.

In a number of embodiments of the invention, the payload of the command further comprises at least one parameter defining the layout of the 2D shape, and said interface is configured to write or read said values of intensities according to said at least one parameter defining the layout of the 2D shape.

For example, the payload may comprise at least one parameter defining an effect to apply to the 2D shape, a color gradient, etc., and the pixel intensities of the 2D shape may be written according to the effect.

Thus, the layout of the 2D shape can be defined according to a minimal amount of information.

However, it is often not possible to define the pixel intensities as a parameter effect, and the pixel intensities must often be defined pixel by pixel.

In other embodiments of the invention, the payload of the command comprises the values of intensities of said subset of pixel, and said interface is configured to write or read said values of intensities according to a pixel path associated to said 2D shape.

Stated otherwise, the payload of the command thus comprises the intensities of pixels themselves, in a predefined order corresponding to a pixel path in the 2D shape, and the intensities of pixels are written or read in the payload in the order defined by the pixel path.

The number of values of intensity to read or write depends upon the number of channels of the color representation of the pixel.

For example:
If the color representation of the pixels is a grayscale representation, a single value of intensity, representing the luminosity of the pixel, can be read or written;
If the color representation of the pixels comprises a plurality of channel, a plurality of values of intensity can be written, corresponding respectively to a plurality of sub-pixels corresponding to each of the color channels. For example, a RGB representation corresponds to 3 values of intensities of Red, Green and Blue sub-pixels respectively, a RG representation corresponds to 2 values of intensities of Red and Green sub-pixels respectively, a RGBW representation corresponds to 4 values of intensities of Red, Green, Blue and White sub-pixels respectively. Any color representation comprising a plurality of channels can be used in according to various embodiments of the invention.

For example, the type of the command may define a 2D shape associated with a predefined pixel path.

In a number of embodiments of the invention, a type of command may correspond to a defined 2D shape defined pixel by pixel with a known predefined pixel path.

This is useful for representing specific 2D shapes. For example, a specific command may be defined to write a mouse pointer of a defined size. The payload then only needs to comprise the intensities of each of the pixel of the mouse cursor in a defined order.

In other embodiments of the invention:
The payload further comprises at least one parameter relative to at least one dimension of the 2D shape;
the size of the payload of the command is dependent upon said at least one dimension;
the pixel path is parameter according to said at least one dimension.

Such embodiments are relative to the writing or reading of shapes of variable sizes. For example, the 2D shape may be a rectangle that may have different sizes, a mouse cursor that may have different sizes, etc.

As noted above, the parameter relative to at least one dimension may be any kind of parameter that allows inferring the dimension (the dimension itself, a surface of the shape, a second pixel position, etc.).

Thus, the at least one dimension allows determining the pixels that belong to the 2D shape, and the pixel path can be parameter accordingly. For example, the pixel path may comprise pixel intensities of pixels line by line, in a predefined direction (for example left to right and top to bottom).

Two concrete examples of commands will now be described.

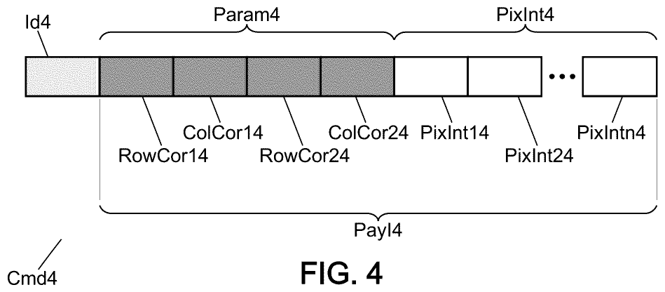

It is now referred to FIG. 4.

FIG. 4 represents an example of command to write a rectangle whose position and dimensions are defined by the positions of two opposite corners, in a number of embodiments of the invention.

The command Cmd4 is a command to write a rectangle in the display screen. The command comprises:
an identifier of command Id4 (in this example the command is 0x10);
payload Payl4 comprising:
   parameters comprising:
      pixel coordinates of one of the corners of the rectangle, for example the top left corner, defined by its row index RowCor14 and column index ColCor14;
      pixel coordinates of the opposite corner of the rectangle, for example the bottom-right corner, defined by its row index RowCor24 and column index ColCor24;
      pixel intensities PixInt4, comprising for each pixel of the rectangle its intensities PixInt14, PixInt24, . . . PixIntn4 in the order defined by the pixel path.

Thus, the parameters allow completely defining the size of the rectangle, and the size of the payload, since the number of pixels to write is equal to the height multiplied by the width of the rectangle and each.

The pixel path may for example correspond to a line-by-line traversal of the rectangle, for example from left to right and from top to bottom. Thus, the order in which the pixels are written is deterministic, and the pixels intensities PixInt14, PixInt24, . . . PixIntn4 can be inserted in the right order in the payload. According to different embodiments of embodiments of the invention, each pixel is associated to a number of values of intensities equal to the number of color channels of the pixel representation.

A similar command may be used to read the pixel intensities in a rectangle. In this case, the parameters can be the same parameters defining the rectangle position and size, and the pixel intensities in the payload PixInt14, PixInt24, PixIntN4 can be read instead of being written.

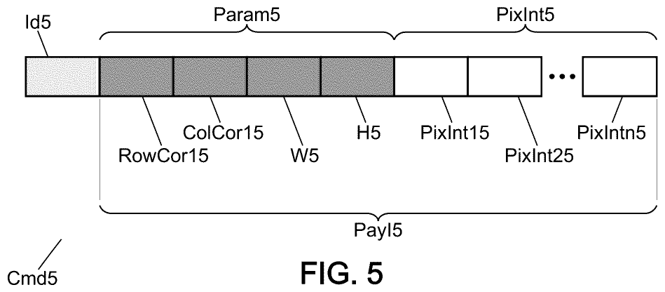

It is now referred to FIG. 5.

FIG. 5 represents an example of command to write a rectangle whose position and dimensions are defined by the position of a corner of the rectangle, and its dimensions, in a number of embodiments of the invention.

The command Cmd5 is a command to write a rectangle in the display screen. The command comprises:
an identifier of command Id5 (in this example the command is 0x11);
payload Payl5 comprising:
   parameters comprising:
      pixel coordinates of one of the corners of the rectangle, for example the top left corner, defined by its row index RowCor15 and column index ColCor15;
      dimensions of the rectangle, defined by its width W5 and height H5.
   pixel intensities PixInt5, comprising for each pixel its intensities PixInt15, PixInt25, . . . PixIntn5 in the order defined by the pixel path.

Thus, the parameters allow completely defining the size of the rectangle, and the size of the payload, since the number of pixels to write is equal to the height multiplied by the width of the rectangle and each. It is worth noting that, in other embodiments of the invention, the position of the rectangle may be defined by the position of a pixel which is not a corner of the rectangle, for example its center.

As in the example of the command Cmd4, The pixel path may for example correspond to a line-by-line traversal of the rectangle, for example from left to right and from top to bottom. Thus, the order in which the pixels are written is deterministic, and the pixels intensities PixInt15, PixInt25, . . . PixIntn5 can be inserted in the right order in the payload.

A similar command may be used to read the pixel intensities in a rectangle. In this case, the parameters can be the same parameters defining the rectangle position and size, and the pixel intensities in the payload PixInt15, PixInt25, PixIntn5 can be read instead of being written.

The examples of FIGS. 4 and 5 provide concrete examples of commands that represent rectangles that whose size and position are parameter in the command.

However, other shapes may be defined by position and size parameters.

For example:
one command may define a discus, by the position of a predefined point (for example a center of the discus, a top, bottom, extreme left or extreme point of the discus, a corner of a square that encompasses the square, or more generally any point that can be located with respect to the discus), and a size of the discus (for example a radius, a diameter, a surface or a perimeter of the discus);
One command may define a triangle, with parameters that define the positions of the 3 corners of the triangle;
Etc.

Each of these commands allows defining deterministically the pixels that belong or not to a shape. Once the pixel that belong to a shape are known, a predefined pixel path can be applied, for example a line-by-line traversal or a column-by-column traversal of the pixels that belongs to the shape to read or write the shape.

The examples of FIGS. 4 and 5 provide concrete examples of commands wherein the pixel intensities themselves are stored in the payload.

It is worth noting that the pixel representation in the payload may be identical or not to the pixel representation in the memories of the pixels.

The representation of the pixels may notably be defined by a bit depth. The values of pixels are often represented as unsigned integers, although the invention is not restricted to this type of representation.

For example, if the representation of pixels in memory is a 24-bits RGB representation (8 bits of intensity for each of the three color channels R, G and B), the pixel intensities PixInt14, PixInt24, PixIntn4, PixInt15, PixInt25 and PixIntn5 may be represented in the payload using the same 24-bits representation, which can be simply copied in the memories of the pixels. The representation is therefore identical between the payload and the pixel memories, and the size of the payload exactly matches the size of the pixel memories to read or write.

In other embodiments of the invention, the pixel representation in the payload may be different from the pixel representation in the memories of the pixel.

For example, parameters of the command may comprise a parameter defining a command pixel depth lower than the depth of the pixels in the static memory, and the interface may be configured to perform a conversion between the command pixel depth and the depth of the pixels in the static memory.

For example, the color representation in the payload may be different from the color representation in the static memories of the pixel. For example, the pixels in the payload may be represented in a grayscale format, while the pixels I the static memory may be represented in a RGB format. In this example, the grayscale intensity stored in the payload can be duplicated in each of the R, G and B channels. In another example, the pixel representation in the payload uses, for each pixel intensity, a pixel depth lower than the pixel depth in the static memory. For example, if the pixel depth in the payload is equal to 6 (with pixel intensities ranging from 0 to 63), and the pixel depth in the static memory is equal to 8 (with pixel intensities ranging from 0 to 255), the conversion from the representation of the payload to the representation in the static memory may consist in multiplying the value of intensity in the payload by 4 in a write mode, and dividing the value of intensity in the static memory by 4 in read mode.

Therefore, this allows further reducing the size of the data that is transmitted.

This disclosure is not limited to the digital display, device, method, computer software and computer-readable non-transient recording medium described here, which are only examples. The invention encompasses every alternative that a person skilled in the art would envisage when reading this text.

1. An active matrix digital display comprising:
a plurality of pixels, each pixel comprising a static memory storing one or more values of intensity of the pixel;
an interface configured, upon the reception of at least one command to:
obtain an identifier of a type of the command;
if the type of the command of the command belongs to at least one type relative to a 2D shape:
reading, in a predefined position of a payload of the command, at least one parameter comprising at least one parameter relative to at least one pixel position in the display screen and at least one parameter relative to at least one dimension of the 2D shape, the size of the payload being dependent upon said at least one dimension of the 2D shape, and a pixel path associated to said 2D shape being parameter according to said at least one dimension of the 2D shape;
one or more of:
writing to the static memories of a subset of pixels of the screen from the payload of the command values of intensities of said subset of pixels based at least on said at least one parameter relative to at least one pixel position, and according to said pixel path, and
reading from said static memories of the subset of pixels values of intensities of said subset of pixels based at least on said at least one parameter relative to at least one pixel position, and according to said pixel path.

2. The digital display of claim 1, wherein the payload of the command further comprises at least one parameter defining the layout of the 2D shape, and said interface is configured to write or read said values of intensities according to said at least one parameter defining the layout of the 2D shape.

3. The digital display of claim 1, wherein said type of the command defines 2D shape associated to a predefined pixel path.

4. The digital display of claim 1, wherein:
said 2D shape is a rectangle;
said at least one parameter comprises:
a row index of a first predefined corner of the rectangle;
a column index of said first predefined corner of the rectangle;
a row index of a second predefined corner of the rectangle, said second predefined corner being opposite to said first predefined corner;
a column index of said second predefined corner of the rectangle.

5. The digital display of claim 1, wherein:
said 2D shape is a rectangle;
said at least one parameter comprises:
a row index of a first predefined corner of the rectangle;
a column index of said first predefined corner of the rectangle;
a height of the rectangle;
a width of the rectangle.

6. The digital display of claim 1 wherein:
said 2D shape is a discus;
said at least one parameter comprises:
a row index of a predefined point associated to the discus;
a column index of the predefined point associated to the discus;
a parameter relative to a size of the discus.

7. The digital display of claim 1, wherein:
said 2D shape is a triangle;
said at least one parameter comprises the positions of the 3 corners of the triangle.

8. The digital display of claim 1, wherein:
said at least one parameter comprises a parameter defining a command pixel depth lower than the depth of the pixels in the static memory;
said interface is configured to perform a conversion between the command pixel depth and the depth of the pixels in the static memory.

9. A display device comprising:
the active matrix digital display of any of;
a processing unit configured to send to the interface of said digital display at least one command.

10. The display device of claim 9, wherein said processing unit is configured, upon the displacement of an object from an initial position to a final position in a 2D scene, to:
send to the interface of said digital display a first command to write pixels of a first 2D shape that encompasses the object at the initial position and represents the background of the 2D scene;
send to the interface of said digital display a second command to write pixels of a second 2D shape that encompasses the object at the final position and represents the object.

11. A method executed by a digital display comprising:
a plurality of pixels, each pixel comprising a static memory storing one or more values of intensity of the pixel;
an interface
said method comprising:
receiving by the interface, at least one command;
if the type of the command of the command belongs to at least one type relative to a 2D shape:
reading in a predefined position of a payload of the command, at least one parameter comprising at least one parameter relative to at least one pixel position in the display screen and at least one parameter relative to at least one dimension of the 2D shape, the size of the payload being dependent upon said at least one dimension of the 2D shape, and a pixel path associated to said 2D shape being parameter according to said at least one dimension of the 2D shape;
one or more of:
writing to the static memories of a subset of pixels of the screen from the payload of the command values of intensities of said subset of pixels based at least on said at least one parameter relative to at least one pixel position, and according to said pixel path, and
reading from said static memories of the subset of pixels values of intensities of said subset of pixels based at least on said at least one parameter relative to at least one pixel position, and according to said pixel path.

12. The Ccomputer software or system firmware comprising instructions to implement at least a part of a method according to claim 11 when the software or system firmware is executed by a processor.

13. The computer-readable non-transient recording medium on which a software or system firmware is registered to implement a method according to claim 11 when the software or system firmware is executed by a processor.
